(19) United States
(12) Patent Application Publication
(10) Pub. No.: US 2002/0085562 A1
(43) Pub. Date: Jul. 4, 2002

(54) IP headers for remote direct memory access and upper level protocol framing

(75) Inventors: John Hufferd, San Jose, CA (US); Julian Satran, Atlit (IL)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/015,316

(22) Filed: Dec. 12, 2001

Related U.S. Application Data
(60) Provisional application No. 60/255,363, filed on Dec. 13, 2000.

(51) Int. Cl. H04L 12/28; H04L 12/56

(52) U.S. Cl. 370/392; 370/471

(57) ABSTRACT

A data packet header including an internet protocol (IP) header, a remote direct memory access (RDMA) header, and a transmission control protocol (TCP) header, wherein the RDMA header is between the IP header and the TCP header.

### CROSS REFERENCE TO RELATED APPLICATIONS

This application claims the benefit of U.S. Provisional Patent Application No. 6,255,363 that is assigned to the assignee of the present invention, and incorporated by reference herein.

### FIELD OF INVENTION

The present invention relates generally to data packet protocols, and in particular, to transportation protocols.

### BACKGROUND

It is known in the art that when data streams are sent over a network, the data is broken into data packets. The packets may then sent be from a transporting processor to a receiving processor.

In order to assist in transportation of the data packet, headers may be attached to the packets. These headers may typically provide the receiving processor with information, such as priority, placement, length, destination, etc. There are many known in the art header protocols, and their purposes thereto.

As an example, very high speed networks require data to be placed directly into their final locations in end-point memory. For this purpose, prior art data packet headers may either explicitly or implicitly comprise a mechanism known as Remote Direct Memory Access (RDMA).

The RDMA may comprise data placement information, or information leading to the data placement information. Upper level protocols (ULP), such as application protocols, may use the RDMA and/or other header data structure information to perform RDMA and ULP framing.

FIG. 1, to which reference is now made, illustrates prior art data packets and associated headers. Although the figure herein illustrates only 3 packets, it is apparent to those skilled in the art that data streams may comprise multitudes of data packets, governed by the principles as described herein.

Data packets 10, 12 and 14 are exemplary data packets, comprising associated headers 16, 18 and 18, respectively, and payloads 28. Header 16 may comprise an Internet Protocol (IP) header 22, a Transmission Control Protocol (TCP) header 24, and a RDMA protocol header 26

RDMA protocol header 26 may comprise fields defining address, name, buffer selection, positions within the buffer, location of payload, length, etc. In some instances, RDMA protocol header 26 may also comprise UPL information for use in UPL framing.

Headers 18 may comprise only IP header 22 and TCP header 24. As such, header 16 may contain information that is pertinent for placement and framing of data packets 10, 12 and 14.

### SUMMARY

The background to the invention has now been presented. We make the following critique or insights about the prior art. Ideally, packets 10, 12 and 14 are transferred, with packet 10 arriving at the receiving processor before packets 12 and 14. The receiving processor may then read header 16, process the information related to placement, length, etc.. and place packets 10, 12 and 14 in their destination locations.

Unfortunately, as happens from time to time with data packets, packet 10 may arrive at the destination after packet 12 or 14, or alternatively, packet 10 may become lost.

Whenever a data packet 10 and its associated header 16, comprising RDMA and/or ULP header information, is lost or delayed, an essential part of the information used to place the packets 12 and 14 is missing. As an example the lost/late header 16 may comprise a data address field and a data length field. The receiving processor, without the address and data length field, may not be able to detect the beginning of the next data packet, and thus may not be able to perform data placement. This phenomenon is known inability to build the RDMA context.

Data packets 12 and 14 may then be temporarily stored until the missing part (e.g. packet 10) is recovered. In some cases, packets 12 and 14 may be dropped and recovered later from the transmitter.

One solution for temporarily storing packets 12 and/or 14 is to store them in a temporary buffer until receipt of packet 10. In such an instance, the temporarily stored packets are easy to locate, however, this solution requires extended CPU time to copy the packets to the required destination. This may cause a memory overload.

Alternatively, the data may be temporarily stored in an adapter memory, or dropped. In such an instance, the amount of data to be temporarily stored or dropped is proportional to the delay bandwidth product for the connection. For networks with large delay bandwidth products, this solution may result in very large memories, poor performance or both.

Additionally problematic, within the TCP/IP family of protocols there does not presently exist a generic, established RDMA structure for ULPs to perform RDMA. Within the TCP/IP family of protocols, every ULP performs RDMA in an ad hoc fashion, via usage of some header information and some transport or network level information.

It is noted that before the advent of very high speed networks, networks transported data so slowly that if a data packet was lost, the network could simply wait for re-transmittal of the data, without suffering any noticeable time lag. However, with the advent of very high speed networks, each lost packet may be a cause for transportation bottle neck. There is therefore a need for a more efficient technique for data packet transfer.

The present invention may provide a method and apparatus for transport protocols for data packets in a data stream.

There is therefore provided in accordance with an embodiment of the present invention a data packet header including an internet protocol (IP) header, a remote direct memory access (RDMA) header, and a transmission control protocol (TCP) header. The RDMA header may be between the IP header and the TCP header and may include URL framing data.

There is therefore provided in accordance with an embodiment of the present invention a data stream including a multiplicity of data packets, wherein at least two of the data packets include an associated IP header, an associated RDMA header, and an associated TCP header. Alternatively, at least two of data packets may include associated RDMA headers. Alternatively, at least two data packets may be each data packet in the data stream.

There is therefore provided in accordance with an embodiment of the present invention a system for transmitting a data stream. The system includes a first transmitting processor adapted to send a data stream, and a second receiving processor adapted to receive a data stream. The data stream may include two or more data packets have associated RDMA headers.

There is therefore provided in accordance with an embodiment of the present invention a method for heading data packets. The method may include the step of inserting an RDMA header between a IP header and a TCP header.

There is therefore provided in accordance with an embodiment of the present invention a computer adapted to send a data stream, or alternatively, a computer adapted to receive a data stream. The stream may include a multiplicity of data packets, wherein at least two of the data packets include, an associated internet protocol (IP) header, an associated remote direct memory access (RDMA) header, and an associated transmission control protocol (TCP) header.

### BRIEF DESCRIPTION OF FIGURES

The present invention will be understood and appreciated more fully from the following detailed description taken in conjunction with the appended drawings in which:

FIG. 1 is a block diagram of a prior art data packet; and

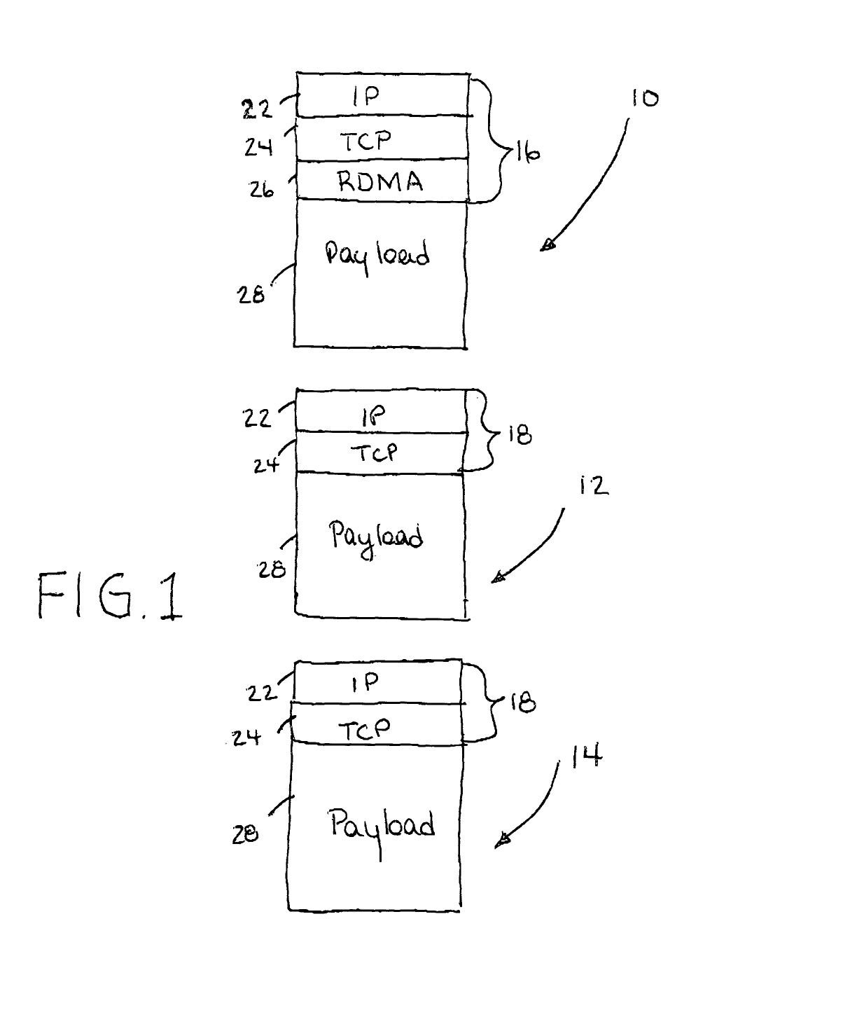

FIGS. 2 and 3 are block diagrams illustrating data packet headers constructed and operative in accordance with preferred embodiments of the present invention; and

FIG. 4 is a block diagram of a computer system operating with a data packet constructed and operative in accordance with preferred embodiments of the present invention.

### DETAILED DESCRIPTION INVENTION

The present invention is a method and apparatus for adapting a transport protocol to meet application needs, without interfering with the transport protocol operation, nor directly affecting its implementation. The transportation protocol may be outside the protocol payload. The transportation protocol may be a data packet header.

An embodiment of the present invention may interpose a RDMA header between the IP header and the transport header (TCP or user datagram protocol (UDP)) and, when needed, an associated trailer may be appended to the transport protocol data unit (PDU). As such, an embodiment of the present invention may provide a mechanism to associate RDMA information with each packet, thus enabling the data within the packets to be steered to their final location, independent of any other packet.

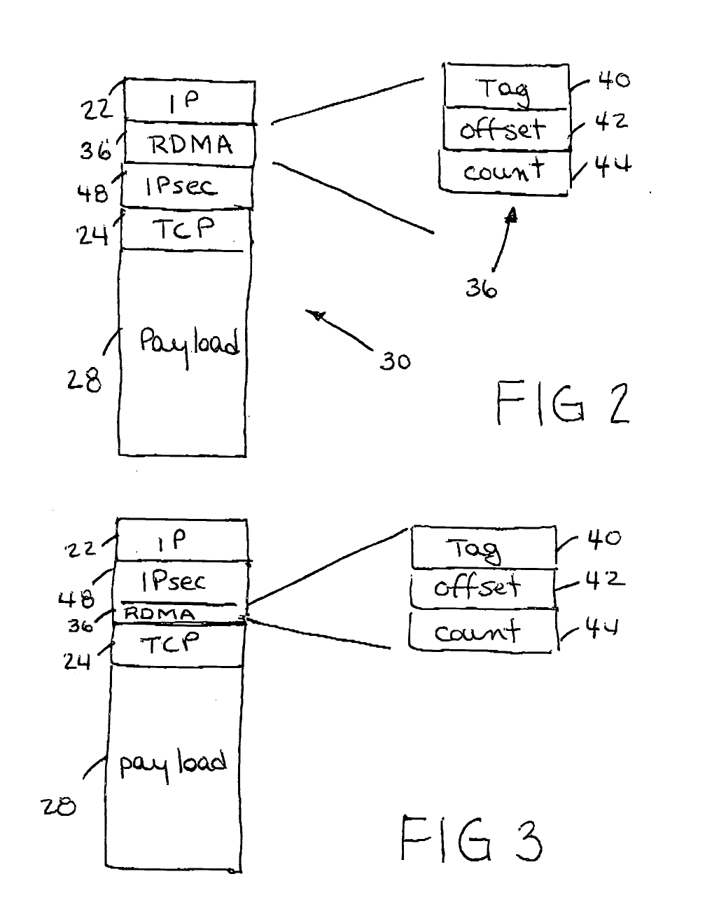

Reference is now made to FIG. 2, a block diagram illustrating data packet 30, constructed and operated according to an embodiment of the present invention. For clarity of explanation, only one packet is shown in FIG. 2. However, in an embodiment of the present invention, a data stream may comprise a multitude of data packets 30, each packet being governed by the principles as described herein.

Exemplary data packet 30 may comprise header 36. Header 36 may comprise IP header 22, a RDMA protocol header 46, an Internet Protocol Security (IPsec) header 48 and TCP header 24.

Reference is now made in parallel to FIG. 3, an illustration of an alternative embodiment of the present invention. In the alternative embodiment illustrated in FIG. 3, IPsec header 48 may comprise RDMA protocol header 46 and/or ULP framing information. The discussions relating to the embodiment illustrated in FIG. 2 are relevant and applicable also to the embodiment illustrated in FIG. 3.

RDMA protocol 46 may comprise a tag 40, an offset header 42 and a count header 44. Tag 40 may also comprise, in one format or another, indication data placement information. As an example, tag 40 may comprise an address and/or a name of the destination location, e.g., the number or designation of the destination buffer. It is noted that although embodiments for tag 40 are listed herein, other alternative embodiments for identification indication are also within the principles of the present invention.

Offset header 42 may comprises additional information about the relative position of the data within a larger ULP data unit, such as, indication that this packet is the second packet in the data stream, and so on. Alternatively, offset header 42 may comprise information indicating relative position within the destination buffer, i.e. byte 51, (meaning this packet is to be placed in byte 51). Alternatively, offset header 42 may comprise information indicating the relative location of the payload within the packet. It is noted that although embodiments for offset header 42 are listed herein, other alternative embodiments for relative position indications are also within the principles of the present invention.

Count header 44 may comprise information indicating what portion, or which portion, of the packet is payload, or alternatively, the length of the packet.

IPsec header 48 may comprise a set of protocols built to provide data integrity and confidentiality (security exchange) over TCP/IP networks. IPsec header 48 may be inserted between the IP header 22 and the TCP header 24. IPsec header 48 may comprise authentication and data integrity (AH) and/or encryption headers, and may build those headers based on a policy and policy specific code. Alternatively, as illustrated in FIG. 3, IPsec headers 48 may comprise RDMA header 36, and/or ULP framing information.

Thus, according to an embodiment of the present invention, each packet 30 may comprise enough information to enable data placement, without dependency on other specific ULP headers packets that may arrive later, or be lost. The present invention may eliminate the storing or dropping packets due to the inability to build the RDMA context.

In alternative embodiments of the present invention, RDMA header 36 may comprise ULP processing information for use in resynchronizing a transport stream. In such an embodiment, RDMA header 36 may compromise UPL framing information. The UPL information may be built using either information provided explicitly by the ULP to policy routines, or information inferred from the ULP data stream. Thus, the present invention may provide a mechanism to enable framing recovery in presence of data packet loses. This mechanism may minimize the effect of an ULP header loss, or reduce delay to at most one ULP data unit.

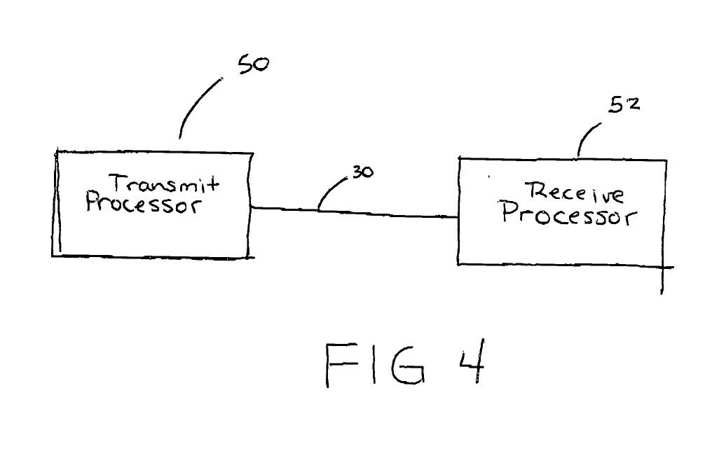

Reference is now made to FIG. 4, an illustration of processors transporting a data stream, constructed and operated according to an embodiment of the present invention. A transporting processor 50 may transmit data stream 54 comprising data packets 30 to a receiving processor 52. It is noted that since each data packet 30 comprises a header 36. As such, receiving processor 52 may be able to direct each packet to its destination without delay.

It is noted that data packets 30 with associated headers 36 may provide a generic transport mechanism for use with application protocols. Per se, headers 36 may also comprise other application specific information. As an example, in an alternative embodiment of the present invention, headers 36 may comprise information enabling the building of simple protocol analyzers. Alternatively, headers 36 may be used to achieve other elusive features for the TCP/IP protocol family, such as end-to-end integrity checks, application specific data compression etc.

Although some of the issues resolved by the present generic transport mechanism invention may be partially solved through alternative mechanisms, each of these solutions is issue specific, and fails to provide a generic transport mechanism for use with application protocols (URLs). As an example, data integrity may be provided through digests included in the payload data, data framing may be attempted using byte stuffing, markers, or higher-level PDUs aligning at fixed boundary, and RDMA may be done with application specific mechanisms.

Unfortunately, implementing these solution for high-speed networks may require additional hardware assists and “in kernel” support in the form of “shims”. However, using shims and building purely within the transport stream leads to rebuilding within a higher layer some of the functions already present in the transport (such as recovery from transport errors in case of a failed data integrity check). Additionally problematic, user application program interface (API) changes may be required for shims. Hence, the transport application of the present invention may be simpler to implement and deploy, and its operation may be more robust.

As an additional advantage, Internet Protocol version 6 (IPV6) enables the incorporation of specialized headers (e.g. headers 36) into the IPV6 destination options. The insertion technique for those options may be used for both IPV4 and IPV6.

It is apparent to those skilled in the art that inherent in discussions concerning data headers are data trailers. Although not specifically mentioned and described herein, many IP headers may be associated with IP trailers, and likewise, RDMA headers may be associated with RDMA trailers. As such, an embodiment of the present embodiment may comprise RDMA data trailers. Some RDMA header and trailers, or ULP header and trailers, may be built by routines registered as application specific extensions, for specific transport flows. These routines may be “activated” by the applications at the two ends of the communication channel through association tables.

In the afore detailed description, numerous specific details are set forth in order to provide a through understanding of the present invention. However, it will be apparent to one skilled in the art that the present invention may be practiced without these specific details. In other instances, well known protocols have not been shown in detail in order not to unnecessarily obscure the present invention.

1. A data packet header comprising:
an internet protocol (IP) header;
a remote direct memory access (RDMA) header; and
a transmission control protocol (TCP) header, wherein said RDMA header is between said IP header and said TCP header.

2. The data packet header of claim 1, wherein said RDMA header comprises URL framing data.

3. A data stream comprising:
a multiplicity of data packets, wherein at least two of said data packets comprise;
an associated internet protocol (IP) header;
an associated remote direct memory access (RDMA) header; and
an associated transmission control protocol (TCP) header.

4. The data stream of claim 3, wherein said at least two of said data packets is each data packet in said stream.

5. A data stream comprising a multiplicity of data packets, wherein at least two of said data packets comprise associated RDMA headers.

6. A method for heading data packets, the method comprising the step of inserting an RDMA header between a IP header and a TCP header.

7. A computer adapted to transmit a data stream, the stream comprising;
a multiplicity of data packets, wherein at least two of said data packets comprise;
an associated internet protocol (IP) header;
an associated remote direct memory access (RDMA) header; and
an associated transmission control protocol (TCP) header.

8. A computer adapted to receive a data stream, the stream comprising;
a multiplicity of data packets, wherein at least two of said data packets comprise;
an associated internet protocol (IP) header;
an associated remote direct memory access (RDMA) header; and
an associated transmission control protocol (TCP) header.
